(19) United States
(12) Patent Application Publication
(10) Pub. No.: US 2011/0182567 A1
(43) Pub. Date: Jul. 28, 2011

(54) STROBE DEVICE

(75) Inventors: Ryutoku ARAKAWA, Osaka (JP); Hiromu KAWAMURA, Takarazuka-shi (JP)

(73) Assignee: SANYO ELECTRIC CO., LTD., Osaka (JP)

(21) Appl. No.: 13/014,251

(22) Filed: Jan. 26, 2011

(30) Foreign Application Priority Data
Jan. 28, 2010 (JP) 2010-017189

(51) Int. Cl. G03B 15/03

(52) U.S. Cl. 396/177

(57) ABSTRACT

A strobe device according to the present invention includes a support portion connected to an apparatus body, and a movable portion having a strobe light emitter and rotatably supported on the support portion, wherein the movable portion includes a rotating member rotatably supported on the support portion, and a frame member fixed to the rotating member, and a shaft portion is provided in the support portion at a position apart from a center of rotation of the rotating member, one end of a spring being engaged with the shaft portion and the other end of the spring being engaged with the frame member, and a stopper wall is integrally formed in the frame member to receive and thereby engage the other end of the spring, and to prevent the spring from coming off.

Japanese Patent Application No. 2010-17189 on which the priority claim of this patent application is based is incorporated herein by reference.

### BACKGROUND OF THE INVENTION

1. Field of the Invention

The present invention relates to a strobe device mounted on an electronic apparatus such as a camera.

2. Description of the Related Art

A camera where a strobe device 81 is mounted on a camera body 8 as shown in FIG. 7 has been proposed. The strobe device 81 can rotate between a closed position where the strobe device 81 is closed with respect to the camera body 8 and an open position where a strobe light emitter 85 is directed frontward. The strobe device 81 is also biased toward the closed position and the open position from an intermediate position between the closed position and the open position by a toggle spring 9.

To be more specific, a guide hole 82 is formed extending in an arc shape at a position apart from the center of rotation of the strobe device 81 in a frame 86 provided inside the strobe device 81. A stopper shaft 83 is slidably fitted in the guide hole 82. The stopper shaft 83 is fixed at a given position with respect to the camera body 8. A boss 84 is formed projecting from the frame 86. One end of the spring 9 is wound around the stopper shaft 83, and the other end of the spring 9 is wound around the boss 84 of the frame 86.

When the strobe device 81 is pressed down from the open position shown in FIG. 7 to the closed position, the stopper shaft 83 relatively moves along the guide hole 82 of the frame 86, to thereby guide the rotation of the strobe device 81. In this process, the spring 9 is first compressed, and elastically restored after the strobe device 81 passes through the intermediate position. The strobe device 81 is thereby biased toward the closed position.

In the strobe device shown in FIG. 7, one end of the spring 9 is engaged with the stopper shaft 83 by being wound therearound, and the other end thereof is engaged with the boss 84 of the frame 86 by being wound therearound. The stopper shaft 83 can also prevent the spring 9 from coming off.

In the strobe device shown in FIG. 7, however, the structure in which one end of the spring 9 is wound around the stopper shaft 83, the other end of the spring 9 is wound around the boss 84 of the frame 86, and the stopper shaft 83 prevents the spring 9 from coming off is employed. Thus, there is a problem that a loop-shaped winding portion needs to be formed at the both ends of the spring 9, and the shape of the spring 9 is thus complicated.

The stopper shaft 83 having an anti-coming-off structure needs to be prepared in advance, and fitted in the frame 86 where the guide hole 82 is formed in an assembling process. As a result, the number of components increases, and the assembling process is complicated. There is also a problem that a mounting space for the stopper shaft 83 is required, so that the device increases in size.

### SUMMARY OF THE INVENTION

A strobe device according to the present invention includes a support portion connected to an apparatus body, and a movable portion having a strobe light emitter and rotatably supported on the support portion, wherein the movable portion can rotate between a closed position where the movable portion is closed with respect to the apparatus body and an open position where the strobe light emitter is directed frontward, and is biased in a closed direction and/or an open direction by a spring.

The movable portion includes a rotating member rotatably supported on the support portion, and a frame member fixed to the rotating member, and a shaft portion is provided in the support portion at a position apart from a center of rotation of the rotating member, one end of the spring being engaged with the shaft portion and the other end of the spring being engaged with the frame member.

A stopper wall is integrally formed in the frame member to receive and thereby engage the other end of the spring, and to prevent the spring from coming off.

### BRIEF DESCRIPTION OF THE DRAWINGS

FIG. 1 is a perspective view illustrating a state in which a strobe device is closed in a camera according to one embodiment of the present invention;

FIG. 2 is a perspective view illustrating a state in which the strobe device is opened in the camera;

FIGS. 3a and 3b are partially cut-away side views at a closed position and an open position of the strobe device;

FIG. 4 is a perspective view illustrating a state in which the strobe device is opened;

FIG. 5 is an exploded perspective view of the strobe device;

FIG. 6 is a perspective view of a frame member and a spring; and

FIG. 7 is a partially cut-way side view of a strobe device in a conventional camera.

### DETAILED DESCRIPTION OF THE PREFERRED EMBODIMENTS

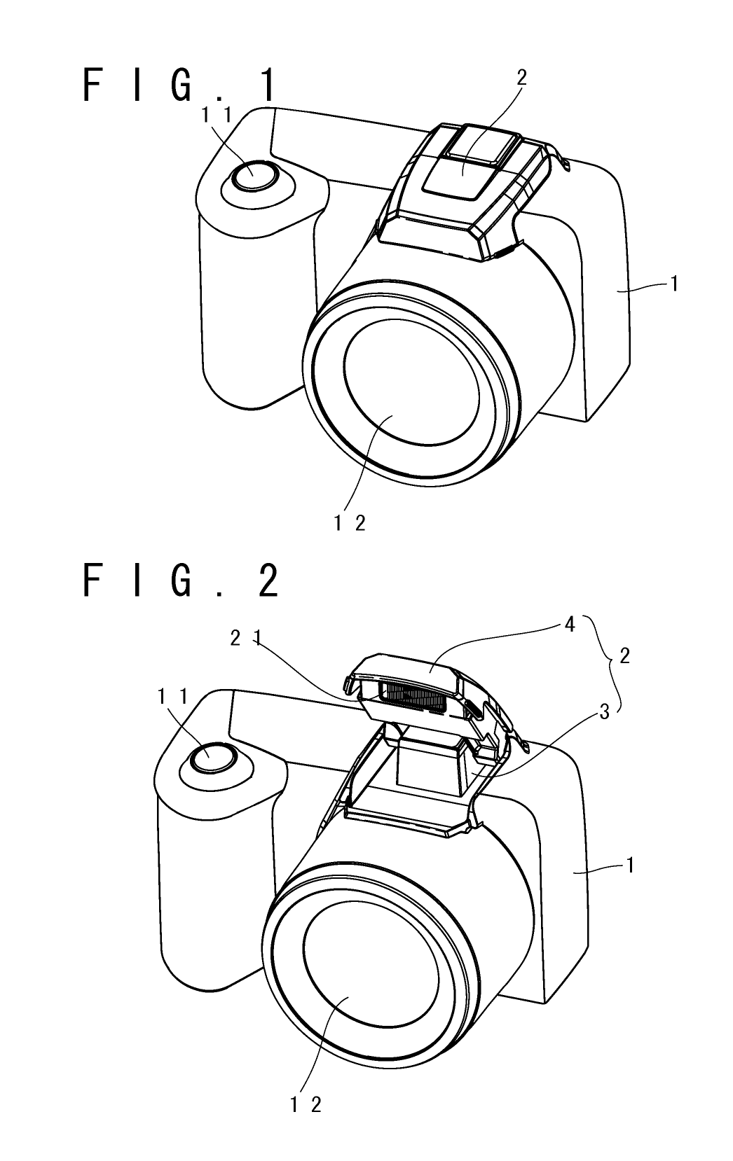

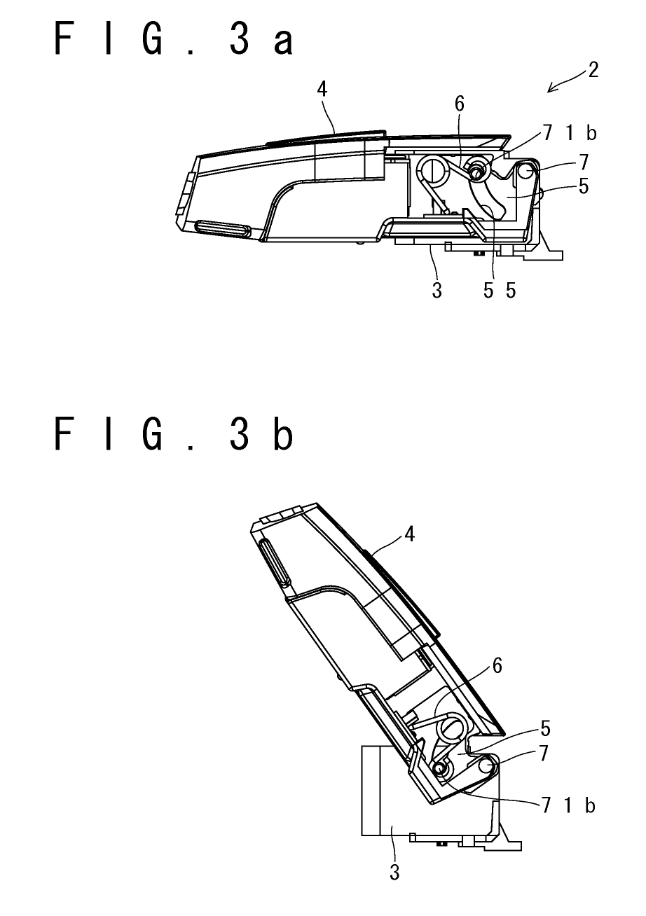

In the following, an embodiment in which the present invention is applied to a camera will be specifically described by reference to the drawings. In a camera according to one embodiment of the present invention, a strobe device 2 is mounted on a camera body 1 including a shutter button 11 and a photographing lens 12 as shown in FIGS. 1 and 2.

As shown in FIG. 2, the strobe device 2 includes a support portion 3 connected to the camera body 1 and a movable portion 4 rotatably supported on the support portion 3. A strobe light emitter 21 is provided in the movable portion 4.

The movable portion 4 can rotate between a closed position where the movable portion 4 is closed with respect to the camera body 1 as shown in FIG. 1 and an open position where the strobe light emitter 21 is directed frontward as shown in FIG. 2.

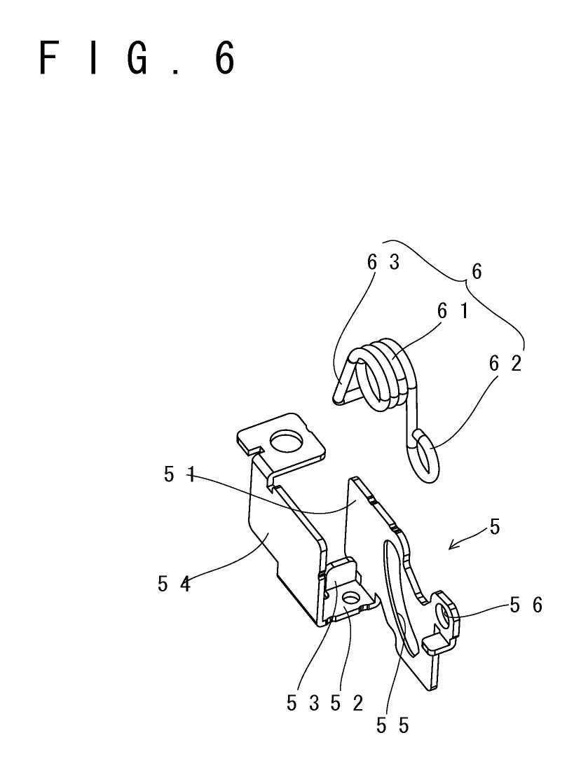

The support portion 3 of the strobe device 2 is made of synthetic resin. A pair of through holes 31 and 31 are formed therein to pivotally support both end portions of a metallic first shaft 7 as the rotating axis of the movable portion 4 as shown in FIG. 5.

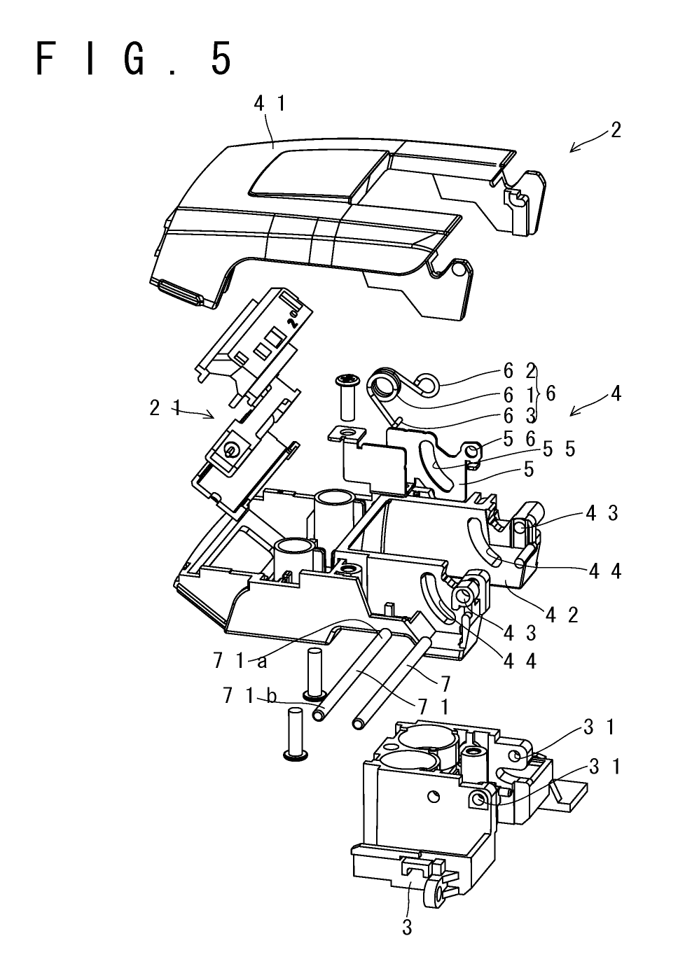

The movable portion 4 includes a rotating member 42 and a cover member 41 made of synthetic resin. The strobe light emitter 21 provided on the rotating member 42 is covered by the cover member 41. A frame member 5 made of sheet metal is fixed to a side portion of the rotating member 42 (see FIG. 4).

As shown in FIG. 5, a pair of through holes 43 and 43 are formed in the rotating member 42 to pivotally support the both end portions of the first shaft 7. A pair of guide holes 44 and 44, through which shaft portions 71a and 71b at the both ends of a metallic second shaft 71 pass, are also formed in the rotating member 42 at a position apart from the through holes 43 and 43. The guide holes 44 and 44 are formed in an arc shape centered on the through holes 43 and 43.

A spring 6 is interposed between the support portion 3 and the rotating member 42. The movable portion 4 is thereby biased toward the closed position and the open position from an intermediate position between the closed position and the open position.

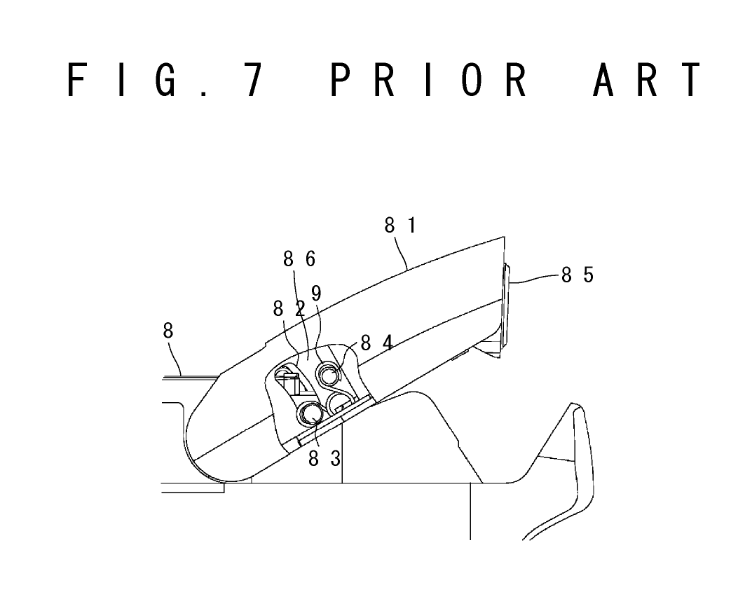

The frame member 5 includes a guide plate portion 51 perpendicular to the rotating axis of the rotating member 42, a first engaging plate portion 52 and a second engaging plate portion 53 parallel to the rotating axis of the rotating member 42 and perpendicular to each other, and an anti-coming-off plate portion 54 parallel to the guide plate portion 51 as shown in FIG. 6.

A through hole 56 through which the first shaft 7 passes, and an arc-shaped guide hole 55 through which the second shaft 71 passes are formed in the guide plate portion 51 of the frame member 5. A gap capable of accommodating the spring 6 is provided between the guide plate portion 51 and the anti-coming-off plate portion 54.

The spring 6 is a toggle torsion spring where a first arm portion 62 and a second arm portion 63 are formed projecting at the both ends of a coil portion 61. The first arm portion 62 is wound in a loop, and the second arm portion 63 is bent in an L shape.

The first arm portion 62 of the spring 6 is engaged with one of the shaft portions 71b of the second shaft 71 shown in FIG. 5 by being wound therearound. The second arm portion 63 is engaged with a corner portion of the first engaging plate portion 52 and the second engaging plate portion 53 of the frame member 5 shown in FIG. 6 by being pressed thereagainst.

In the aforementioned strobe device 2, the movable portion 4 can rotate about the first shaft 7. In this process, the shaft portions 71a and 71b at the both ends of the second shaft 71 relatively slide along the guide holes 44 and 44 of the rotating member 42 and the guide hole 55 of the frame member 5, thereby guiding the rotation of the rotating member 42. The spring 6 is stretched or compressed in association with the rotation of the rotating member 42, and the rotation of the rotating member 42 is biased by the repulsion force.

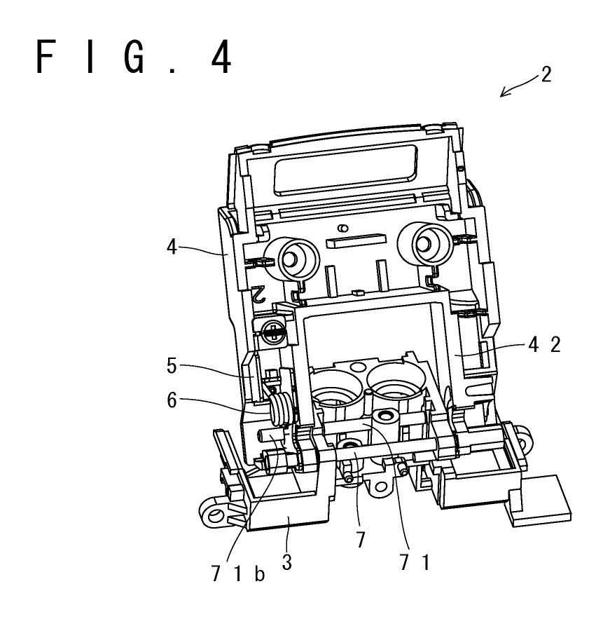

When the movable portion 4 is at the closed position as shown in FIG. 3a, the shaft portion 71b of the second shaft 71 is located at one end of the guide hole 55 of the frame member 5. In this state, the spring 6 is slightly compressed, and the movable portion 4 is held at the closed position by the repulsion force.

When the movable portion 4 is opened from the closed position to the intermediate position against the biasing force of the spring 6, the spring 6 is further compressed in this process. When the movable portion 4 passes through the intermediate position, the spring 6 is reversed. The movable portion 4 is biased toward the open position shown in FIG. 3b by the repulsion force of the spring 6. The movable portion 4 is thereby automatically opened to the open position.

At the open position shown in FIG. 3b, the shaft portion 71b of the second shaft 71 is located at the other end of the guide hole 55 of the frame member 5. In this state, the spring 6 is slightly compressed, and the movable portion 4 is held at the open position by the repulsion force. An end portion of the inner circumferential surface of the guide hole 55 of the frame member 5 works as a stopper for receiving the shaft portion 71b.

In the aforementioned strobe device 2, the second arm portion 63 of the spring 6 is engaged with the first engaging plate portion 52 and the second engaging plate portion 53 of the frame member 5 shown in FIG. 6 by being pressed thereagainst, and is also held between the guide plate portion 51 and the anti-coming-off plate portion 54, so that the spring 6 is prevented from coming off.

The frame member 5 is made of sheet metal. The guide plate portion 51 where the guide hole 55 is formed, the first and second engaging plate portions 52 and 53 for receiving and engaging the second arm portion 63 of the spring 6, and the anti-coming-off plate portion 54 for preventing the second arm portion 63 of the spring 6 from coming off from the first and second engaging plate portions 52 and 53 are integrally formed therein.

Accordingly, as compared to a conventional configuration where a stopper shaft 83 is fitted in a frame 86, and one end of a spring 9 is wound around the stopper shaft 83 as shown in FIG. 7, the number of components, the space, and the number of assembling steps can be reduced since the stopper shaft 83 is not required.

Also, as shown in FIG. 5, the second arm portion 63 of the spring 6 is formed in an L shape. Thus, the mounting space and the manufacturing cost can be reduced since the shape of the spring 6 is simplified.

Moreover, since the structure in which the shaft portions 71a and 71b at the both ends of the single second shaft 71 are engaged with the guide holes 44 and 44 of the rotating member 42 and the guide hole 55 of the frame member 5 is employed, the number of components can be reduced.

The configuration of each portion of the present invention is not limited to that in the aforementioned embodiment, and various modifications may be made therein by a person skilled in the art without departing from the spirit of the present invention as expressed in the claims. The present invention is also not limited to a camera, and may be applied to various electronic apparatuses having a strobe device.

What is claimed is:

1. A strobe device comprising a support portion connected to an apparatus body, and a movable portion having a strobe light emitter and rotatably supported on the support portion, wherein the movable portion can rotate between a closed position where the movable portion is closed with respect to the apparatus body and an open position where the strobe light emitter is directed frontward, and is biased in a closed direction and/or an open direction by a spring,
the movable portion comprises a rotating member rotatably supported on the support portion, and a frame member fixed to the rotating member, and a shaft portion is provided in the support portion at a position apart from a center of rotation of the rotating member, one end of the spring being engaged with the shaft portion and the other end of the spring being engaged with the frame member, and
a stopper wall is integrally formed in the frame member to receive and thereby engage the other end of the spring, and to prevent the spring from coming off.

2. The strobe device according to claim 1, wherein an arc-shaped guide hole is formed in the frame member to guide relative movement of the shaft portion in association with rotation of the rotating member.

3. The strobe device according to claim 2, wherein the frame member is made of sheet metal, and comprises
a guide plate portion where the guide hole is formed,
one or a plurality of engaging plate portions formed perpendicular to the guide plate portion and against which the other end of the spring is pressed by an elastic force thereof, and
an anti-coming-off plate portion formed parallel to the guide plate portion via the engaging plate portion to prevent the other end of the spring from coming off from the engaging plate portion, and
the engaging plate portion and the anti-coming-off plate portion form the stopper wall.

4. The strobe device according to claim 1, wherein one end of the spring is wound around the shaft portion, and the other end of the spring is bent in an L shape to be pressed against the stopper wall of the frame member.

5. The strobe device according to claim 1, wherein a shaft is suspended in the support portion at a position apart from the center of rotation of the rotating member, an arc-shaped guide hole, through which both end portions of the shaft pass, is formed in the rotating member to guide relative movement of the shaft in association with rotation of the rotating member, and one of the end portions of the shaft forms the shaft portion.
